(19) United States
(12) Patent Application Publication
(10) Pub. No.: US 2010/0154262 A1
(43) Pub. Date: Jun. 24, 2010

(54) LETTER-LUMINESCENT FOOTBOARD

(76) Inventor: Joo-Hyun KIM, Seoul (KR)

Correspondence Address: HOLME ROBERTS & OWEN LLP, 1700 LINCOLN STREET, SUITE 4100, DENVER, CO, 80203, US

(21) Appl. No.: 12/536,653

(22) Filed: Aug. 6, 2009

Related U.S. Application Data
(62) Division of application No. 11/845,938, filed on Aug. 28, 2007, now abandoned.

(30) Foreign Application Priority Data
Apr. 24, 2007 (KR) 10-2007-0039995
Jun. 11, 2007 (KR) 10-2007-0056831

(51) Int. Cl. G09F 13/20

(52) U.S. Cl. 40/550

(57) ABSTRACT

A letter-luminescent footboard is disclosed. The footboard absorbs impact and emits light by coupling luminous bodies forming a letter or graphic by a coupling means. The footboard is configured to include: a footboard base having, coupling holes displaying a letter, graphic, or number; luminous bodies coupled to the coupling holes by insertion to be separated therefrom; and a luminous body support plate which supports the luminous bodies, is integral with the luminous bodies, and is separated therefrom and coupled thereto from below the footboard base. Thus, the footboard base can be easily washed.

### BACKGROUND OF THE INVENTION

1. Field of the Invention

The present invention relates to a letter-luminescent footboard, which couples luminous lamps to a footboard at predetermined intervals so that they combine to form a letter, seals the back surface of the footboard base to a back plate to hold a control unit, which is for applying and controlling power to each of the luminous lamps, and protects the luminous lamps even if when they are stepped on. The present invention also relates to an easily washable letter-luminescent footboard, and more particularly to an easily washable letter-luminescent footboard, which has luminous holes forming a letter or graphic placed on an existing footboard and has a support plate for supporting luminous bodies corresponding to the luminous holes so as to be separated from and coupled to the footboard, thereby allowing the footboard to be more easily washed, stored, and repaired.

2. Description of the Related Art

Generally, a footboard utilizes letters or graphics printed on a rubber plate or the like that form a footboard base. As for existing footboards, simple letters or graphics are printed thereon, and real image printing methods of printing a picture or the like are common in recent years.

However, such images cannot be seen from a distance at night, unless there is an external lighting installed thereon. Thus, a lighting means should be additionally installed, which is inconvenient.

### SUMMARY OF THE INVENTION

Therefore, the present invention has been made in view of the above problems, and it is an object of the present invention to provide a letter-luminescent footboard, which is beyond the concept of existing footboards.

It is another object of the present invention to provide a letter-luminescent footboard, which displays letters by lamps, and which can be folded for increased portability and easier storage.

It is another object of the present invention to provide a letter-luminescent footboard, which emits light from letters using the light of lamps, rather than using a photoluminescence method for receiving light and emitting the same, and which cuts down costs and reduces the weight of the footboard by using a diffusive luminous body that diffuses and emits light so as to display letters with a small number of lamps.

It is an object of the present invention to provide an easily-washable letter-luminescent footboard, which allows the footboard and the support plate having letters or graphics to be separable to enable easier washing.

It is another object of the present invention to provide an easily washable letter-luminescent footboard, which can be used by selecting various light emitting means since a luminous body forming letters or graphics is coupled to a support plate.

It is another object of the present invention to provide an easily washable letter-luminescent footboard, which can offer various guidance and advertisement effects by a combination of lighting and printing by spreading the same over a graphics printing portion that has letters or graphics printed on the regions forming luminous holes.

It is another object of the present invention to provide an easily washable letter-luminescent footboard, which allows luminous holes to form a large space of a predetermined dimension, and allows luminous bodies for displaying letters or graphics on this space and a support plate for supporting the luminous body to be integrally placed at the region corresponding to the luminous holes, thereby making the footboard stereoscopic.

In accordance with first to third embodiments of the present invention, luminous lamps are coupled to a footboard base to display letters, the back surface of the footboard base is coupled to a back plate for sealing, and a control unit for operating the luminous lamps is stored on the back side of the footboard base. The present invention provides a letter-luminescent footboard that includes: a footboard base for sealing and coupling luminous lamps thereto at predetermined intervals so that the luminous lamps are combined to form letters; a control unit for applying and controlling power to each of the luminous lamps coupled to the footboard base; and a back plate for covering the entire back surface of the footboard base holding the luminous lamps and the control unit by using a sealing means.

In accordance with first to third embodiments of the present invention, there is provided a letter-luminescent footboard that includes: diffusive luminous bodies the bottom surface of which is a flat plane surface, the inside of which forms a core layer for transmitting light, and the top surface of which forms a convex surface to diffuse and emit the light of luminous lamps installed on the bottom surface onto the convex surface; a footboard base for coupling the diffusive luminous bodies at predetermined intervals so as to be combined to form a letter; a control unit for applying and controlling power to each of the diffusive luminous bodies coupled to the footboard base; and a back plate for covering the back surface of the footboard base holding the luminous lamps and the control unit by using a sealing means.

In accordance with fourth to seven embodiments of the present invention, there is provided a letter-luminescent footboard that includes: a footboard base having coupling holes displaying a letter, graphic, or number; luminous bodies coupled to the coupling holes by insertion so as to be separated therefrom; and a luminous body support plate which supports the luminous bodies, is integral with the luminous bodies, and is separated therefrom and coupled thereto from below the footboard base. Thus, the footboard base can be easily washed.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a front view depicting a first embodiment of the present invention;

FIG. 2 is an enlarged cross sectional view taken along line A-A of FIG. 1;

FIG. 3 is an enlarged cross sectional view showing a second embodiment of the present invention taken along line A-A of FIG. 1;

FIG. 4 is an enlarged cross sectional view taken along line B-B of FIG. 1;

FIG. 5 is a cross sectional view showing a third embodiment;

FIG. 6 is a control configuration view of the present invention;

FIG. 7 is an exploded perspective view of a diffusive luminous body used in FIG. 3 of the present invention;

FIG. 8 is a cross sectional view taken along line C-C of FIG. 7;

FIG. 9 is an enlarged cross sectional view of essential parts of FIG. 8;

FIG. 10 is a plane view showing another example of a diffusive luminous body used in the third embodiment;

FIG. 11 is a plane view showing still another example of a diffusive luminous body used in the third embodiment;

FIG. 12 is a plane view showing another example of the present invention;

FIG. 13 is an enlarged exploded view of essential parts of a fourth embodiment of the present invention;

FIG. 14 is an enlarged exploded view of essential parts of a fifth embodiment of the present invention;

FIG. 15a is an exploded view of the fourth embodiment of the present invention;

FIG. 15b is a cross sectional view of an assembly state of FIG. 4a;

FIG. 16a is an enlarged exploded view of essential parts of a sixth embodiment of the present invention;

FIG. 16b is a cross sectional view of an assembly state of essential parts of FIG. 16a;

FIG. 17a is an exploded perspective view of a seventh embodiment of the present invention;

FIG. 17b is a perspective view of an assembly state of FIG. 17a;

FIG. 18 is a plane view showing another example of a luminous body of the sixth embodiment of the present invention;

FIG. 19 is a plane view showing still another example of the luminous body of the sixth embodiment of the present invention;

FIG. 20 is an enlarged exploded perspective view showing one example of the luminous body of the sixth embodiment of the present invention;

FIG. 21 is a view showing the diffusion of light in an assembly state of FIG. 20; and

FIG. 22 is a cross sectional view showing the diffusion of light of FIG. 21.

### DETAILED DESCRIPTION OF THE PREFERRED EMBODIMENTS

Preferred embodiments according to a letter-luminescent footboard of the present invention will be described in detail with reference to the accompanying drawings.

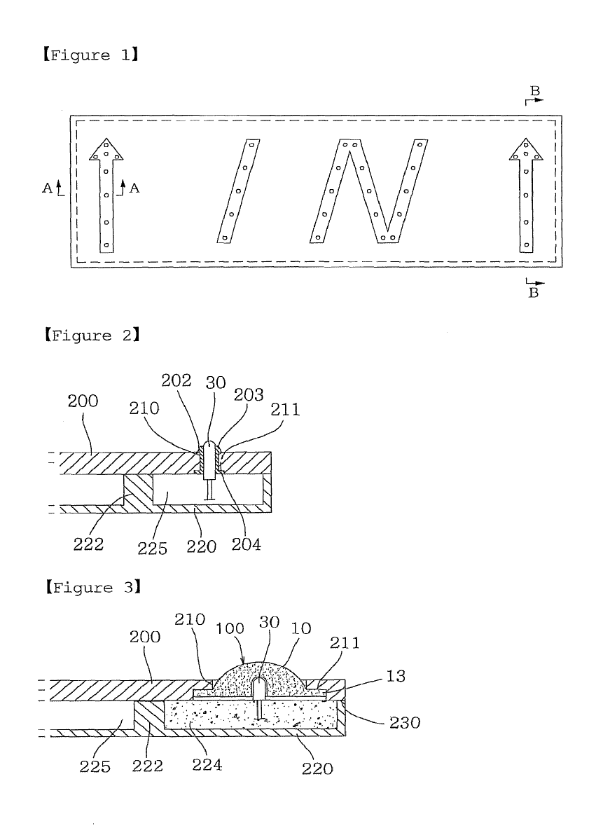

FIG. 1 is a front illustration of a first embodiment of the present invention. FIG. 2 is an enlarged cross sectional view taken along line A-A of FIG. 1.

The letter-luminescent footboard includes: a footboard base 200 for sealing and coupling luminous lamps 30 at predetermined intervals so that they are combined to form a letter; a control unit 130 for applying and controlling power to each of the luminous lamps 30 coupled to the footboard base 200; and a back plate 220 for covering the entire back surface of the footboard base 200 holding the luminous lamps 30 and the control unit 130 by using a sealing means 230. In this case, a coupling hole 210 for placing a luminous lamp assembly (luminous body) thereon is formed on the footboard base 200, and the luminous lamp assembly (luminous body) to be fit into the coupling hole 210 is fastened by a fastening means 202 selected from the group of a bonding agent, silicon, and other sealing plate materials. The fastening means 202 includes a fastening edge 204 for supporting the luminous lamps 30 and a fastening hook 203 to be fastened to the footboard base 200. Although the above description has been made with respect to a case in which the luminous lamps 30 are coupled to the footboard base 200 to display letters thereon, this invention is not limited thereto and it can be implemented in various forms including numbers, symbols, pictures, characters, etc. The footboard base 200 and the back plate 220 are formed of a waterproof cloth, a carpet, a rubber plate, a wall-hanging plate, etc. A space 225 through which a wire is moved is provided between coupling means 222 since the coupling means 222 support the footboard base 200.

The luminescent lamps 30 are arranged to form letters through the control unit 130 as shown in FIG. 6 to be depicted later. Thus, when a switch 131 is turned on, power of a battery 132 is supplied to the luminescent lamps 30, and accordingly the letters become luminescent even at night to thus enable use in both day and nights. Further, the footboard easy to move as it can be folded or rolled by using the flexible function of the footboard base 200, and it further convenient since it may be unfolded event when it rains, due to it being waterproof.

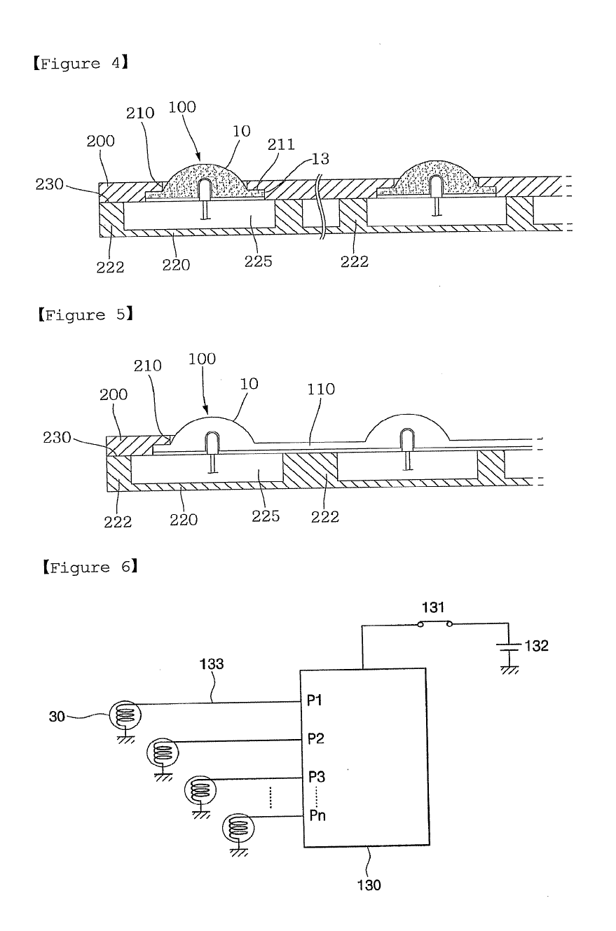

FIG. 3 is an enlarged cross sectional view showing a second embodiment of the present invention taken along line A-A of FIG. 1. FIG. 4 is an enlarged cross sectional view taken along line B-B of FIG. 1.

The letter-luminescent footboard includes: luminous bodies 100 the bottom surface of which is a flat plane surface, the inside of which forms a core layer 11 for transmitting light, and the top surface of which forms a convex surface to diffuse and emit light of luminous lamps 30 installed on the bottom surface onto the convex surface; a footboard base 200 for coupling the luminous bodies 100 at predetermined intervals so as to be combined to form a letter; a control unit for applying and controlling power to each of the diffusive luminous bodies 100 coupled to the footboard base 200; and a back plate 220 for covering the entire back surface of the footboard base 200 holding the luminous lamps 30 and the control unit 130.

A coupling hole 210 for supporting each of the diffusive luminous bodies 100 to be coupled at intervals recognizable by letters, edge portions 13, and receivable edge grooves 211 are formed on the footboard base 200.

The sealing means 230 can be selected from means including a zipper, high-frequency fusion bonding, a magic tape, etc., and other sealable means can be used.

Although the above description has been made with respect to a case in which the diffusive luminous bodies 100 are coupled to the footboard base 200 to display letters thereon, this invention is not limited thereto and it can be implemented in various forms including numbers, symbols, pictures, characters, etc. The footboard base 200 and the back plate 220 are coupled and supported at a predetermined distance interval by an intermediate coupling means 222 such that there is no difference in thickness. A cushion material 224, such as a sponge, silicon, rubber, etc., may be placed in spaces 225 and 224 between the coupling means 222 to absorb an impact on the footboard base 200.

FIG. 5 shows a third embodiment of the present invention, in which the luminous bodies 100 are connected by a base 110 to form a letter or graphic.

FIG. 6 is an illustration of a control configuration of the present invention, in which the luminous lamps 30 use a control technique of a general technology for control by one control circuit (i.e., a well-known control circuit that enables sequential light emission using a shift register, differentiates the colors of the luminous lamps 30, has a plurality of luminous lamps 30 installed therein, or enables a flickering operation), and thus a detailed description thereof will be emitted.

As for the operation of a control unit 130, the power of a battery 132 is applied by a switch 131, and the applied power is adapted to intermittently or continually operate the luminous lamps 30 through an electric wire 133. A driving program is stored in the control unit 130 so that each of the lamps 30 is individually, simultaneously, or selectively driven. In this case, the battery 132 is a DC power source. As the battery, a common battery may be used, or an adapter or the like for receiving power from a commercial power source or an AC power source equivalent thereto and outputting DC power may be used. Further, if necessary, a solar cell capable of receiving sunlight and recharging itself may be used.

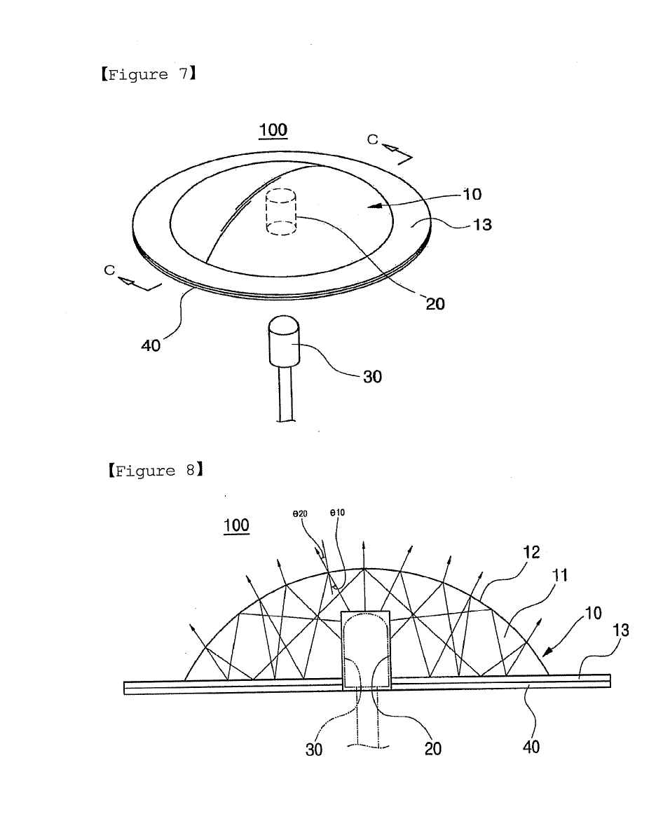

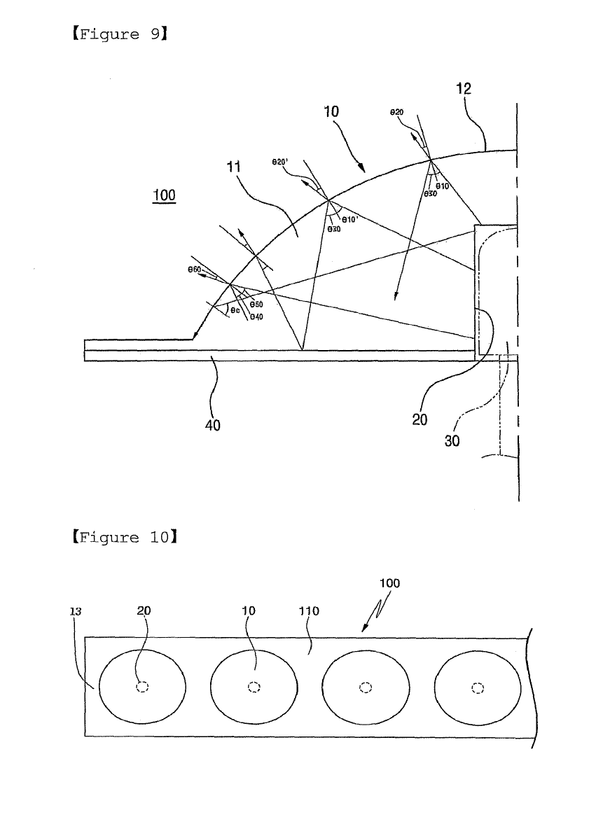

FIG. 7 is an exploded perspective view of a diffusive luminous body used in the present invention. FIG. 8 is a cross sectional view taken along line C-C of FIG. 7. FIG. 9 is an enlarged cross sectional view of essential parts of FIG. 8.

Each of the luminous bodies 100 diffusing light includes: a convex lens type convex portion 10 made of a flexible thermoplastic (thermosetting) polymer, the top surface of which is a convex surface and forms a clad layer 12 providing a reflection angle so that light of an internal light source have a uniform luminance on the surface; an insertion hole 20 formed in an axial direction on the center of the bottom surface of the convex portion 10; a luminous lamp 30 which is an internal light source to be inserted into the insertion hole 20; and a reflective layer 40 integrally coupled to the plane surface of the bottom surface of the convex portion 10, wherein a supporting edge portion 13 of a ring plate shape to be coupled to the footboard base 200 is integrally coupled to the edge of the convex portion 10.

FIG. 10 is a plane view showing an example of separating only a luminescent device used in FIG. 4, in which luminous bodies 100 are formed integral with a substrate 110 made of a flexible polymer having a predetermined length at predetermined intervals.

FIG. 11 is a plane view showing another example of a luminescent device used in FIG. 5, in which an extension hole 13-1 for enabling sequential extension and connection through a connector 120 is formed on the edge portion 13 forming the edge of the convex portion 10 of the diffusive luminous body 100.

When the luminous lamps 30 serving as light sources generates light forward and laterally (side-lobe) on the clad layer 12 forming the surface of the core layer 11 as shown in FIGS. 8 and 9, the luminous body 100 of the present invention functions such that the surface of the convex portion 10 has a uniform luminance because the light is transmitted at an incident angle (∂10) and at a refraction angle (∂20) with respect to the normal line of each point of the convex surface forming the surface of the clad layer 12. Although the light of the luminous lamps 30 serving as light sources goes straight ahead on the core layer 11, the clad layer 12 forms a curved surface. Therefore, incident angles (∂10) (∂10′)(∂50) at most of the normal lines do not exceed a critical angle (∂c), to thus form refraction angles (∂20)(∂20′)(∂60) at each of the normal lines of the convex surface, so that the light is transmitted, thereby forming a uniform luminance on the surface of the convex portion (this luminous body 100 acts as a diffusive luminous body for uniformly lighting up the convex portion 10 having a larger diameter than the diameter of the luminous lamps 30, rather than in the concept of simple surface emission in which the light through the luminous lamps 30 merely goes straight ahead). It is apparent that each of the incident angles (∂10)(∂10′)(∂50) form refracting angles (∂30)(∂30′)(∂40) and refract light to the inner surface of the core layer 11 to thus transmit the light at a certain point, which may improve the luminance. In this case, the clad layer 12 is medium (i.e., an air layer) which is provided with the direct advance of uniform light through a thermoplastic (thermosetting) synthetic resin polymer forming the core layer 11, thereby differentiating the refractivity.

Moreover, a semitransparent layer may be added to the surface of the clad layer 12 to provide a softened brightness, or fine mineral particles, such as TiO₂, may be added into the core layer 11 to transmit light in a semitransparent state.

By way of example as shown in FIG. 1 of the footboard base 200 forming a footboard using the luminous bodies 100 having the function of diffusive light emission, the luminous bodies 100 are arranged at predetermined intervals so as to form an array of letters (“IN”) to a recognizable extent. As for the arrangement method, as shown in FIGS. 3 and 4, the convex portion 10 is exposed on the coupling hole 210 formed on the footboard base 200, and the edge portion 13 is coupled to the edge of the coupling hole 210 by a high-frequency fusion bonding (or other coupling means (i.e., means selected from various coupling means such as bonding or clipping) so as to be overlapped with it. Of course, in this case, in the region forming a letter, as in the third embodiment of FIG. 5, the diffusive luminous bodies 100 having the construction as shown in FIG. 10 or 11 may be coupled to the footboard base 200.

In the present invention thus constructed, each of the luminous bodies 100 is coupled to the footboard base 200 so as to form a letter or graphic, and the control unit 130, luminous lamps 30, and wires 133 as shown in FIG. 6 are connected thereto so as to illuminate the luminous lamps 30 installed at the luminous bodies 100, and as shown in FIGS. 2 to 5, the back plate 220 is sealed to the back surface of the footboard base 200 by a sealing means 230 (i.e., high-frequency fusion bonding) to enable waterproofing.

Accordingly, when a switch 131 is turned on to supply power of a battery 132 to the control unit 130, the luminous lamps 30 disposed to display letters are turned on, and thus a letter-luminescent footboard that displays letters.

In particular, the diffusive luminous bodies 100 emitting light to display letters act to diffuse the light emission area of the lamp. Thus, the present invention can display a letter brightly even if a small number of luminous lamps 30 is used, can cut down costs unlike the letter luminescent method that uses many lamps even if the number of used luminous lamps 30 is decreased, can provide the effect of softened light emission because the convex portion 10 forms a uniform luminance as the light is diffused, thereby offering the effect of a softened light emission, and can provide a letter-luminescent placard which non-glaring and is appealing.

Further, with respect to the normal line of each point of the convex surface forming the surface of the clad layer 12, as illustrated in FIG. 9, light is transmitted at an incident angle (∂10) and at a refracting angle (∂20), and accordingly the surface of the convex portion 10 forms a uniform luminance. Although the light of the luminous lamps 30 serving as light sources go straight ahead on the core layer 11, the clad layer 12 forms a curved surface. Therefore, incident angles (∂10)(∂10′)(∂50) at most of the normal lines do not exceed a critical angle (∂c), to thus form refraction angles (∂20)(∂20′)(∂60) at each of the normal lines of the convex surface, so that the light is transmitted, thereby forming a uniform luminance on the surface of the convex portion (this luminous body 100 acts as a diffusive luminous body for uniformly lighting up the convex portion 10 having a larger diameter than the diameter of the luminous lamps 30, rather than in the concept of simple surface emission in which the light through the luminous lamps 30 merely goes straight ahead). It is apparent that each of the incident angles (∂10)(∂10′)(∂50) form refracting angles (∂30) (∂30′)(∂40) and refract light to the inner surface of the core layer 11 to thus transmit the light at a certain point, which may improve the luminance. In this case, the clad layer 12 is medium (i.e., air layer) which is provided with the direct advance of uniform light through a thermoplastic (thermosetting) synthetic resin polymer forming the core layer 11, thereby differentiating the refractivity.

By way of example as shown in FIG. 1 of the footboard base 200 forming a footboard using the luminous bodies 100 having the function of diffusive light emission, the luminous bodies 100 are arranged at predetermined intervals so as to form an array of letters (“IN”) to a recognizable extent. As for the arrangement method, as shown in FIGS. 3, 4 and 5, the front surface 15 is exposed on the coupling hole 210 formed on the footboard base 200, and the edge portion 13 is coupled to the edge of the coupling hole 210 by a high-frequency fusion bonding or other coupling means (i.e., means selected from various coupling means such as bonding or clipping) so as to be overlapped with it.

Fourth to seventh embodiments, which are another embodiments of the present invention, will be described in detail with reference to the accompanying drawings.

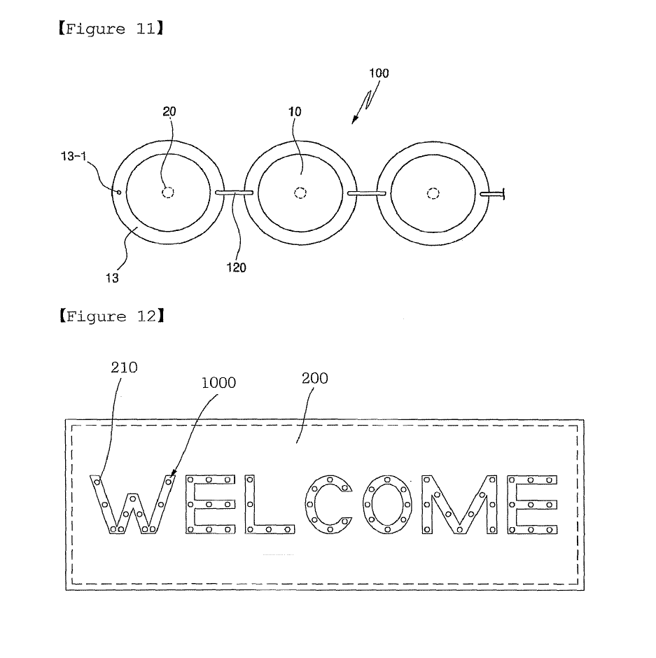

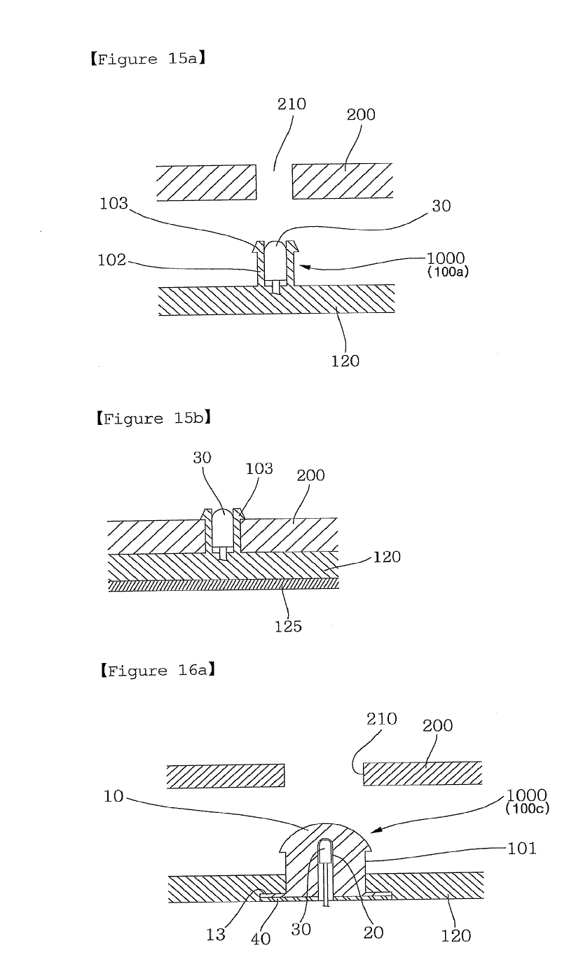

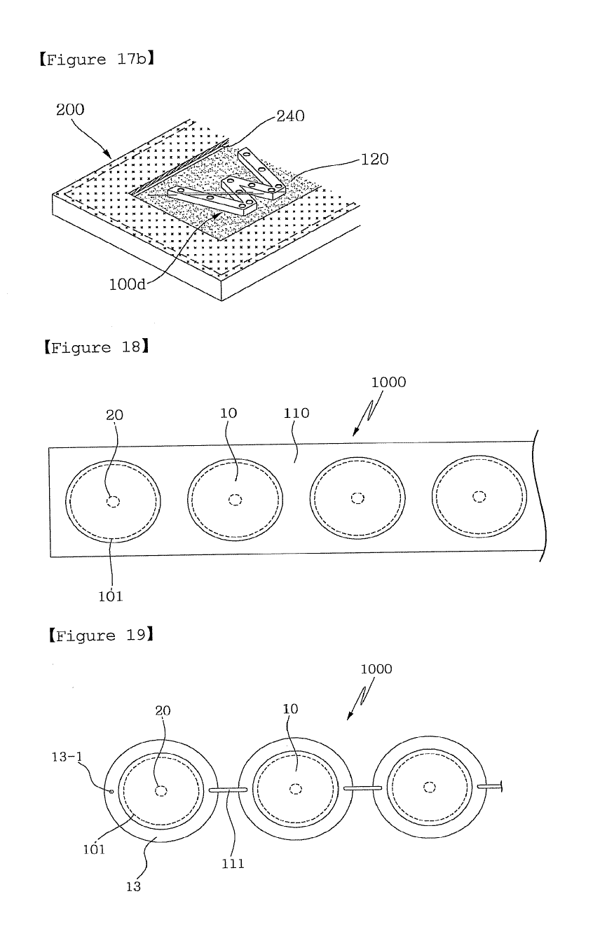

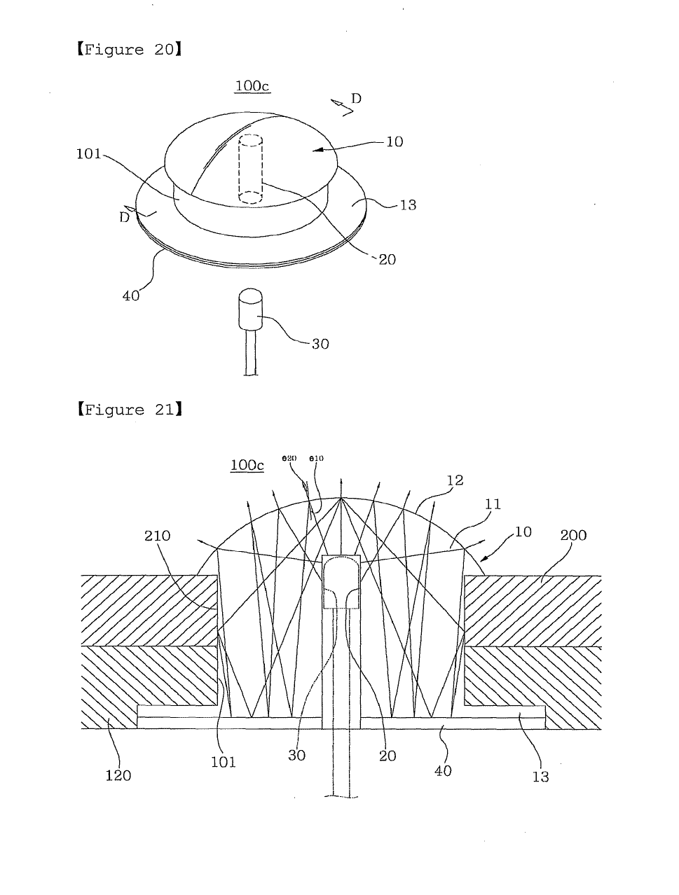

FIGS. 12, 13, and 15 are views showing a fourth embodiment, FIG. 14 is a view showing a fifth embodiment, FIG. 16 is a view showing a sixth embodiment, FIG. 17 is a view showing a seventh embodiment, FIGS. 18 and 19 are views showing the fifth, sixth, and seventh embodiments, and FIGS. 20, 21, and 22 are views showing the sixth embodiment.

In each of the embodiments, basically, a letter-luminescent footboard includes: a footboard base 200 having coupling holes 210 displaying a letter, graphic, or number; luminous bodies 1000 coupled to the coupling holes 210 by insertion so as to be separated therefrom; and a luminous body support plate 120 which supports the luminous bodies 1000, is integral with the luminous bodies 1000, and is separated therefrom and coupled thereto from below the footboard base 200. Thus, the footboard base 200 can be easily washed.

As above, the coupling holes 210 have a shape of a letter or graphic, and the luminous bodies 1000 have a corresponding letter or graphic shape.

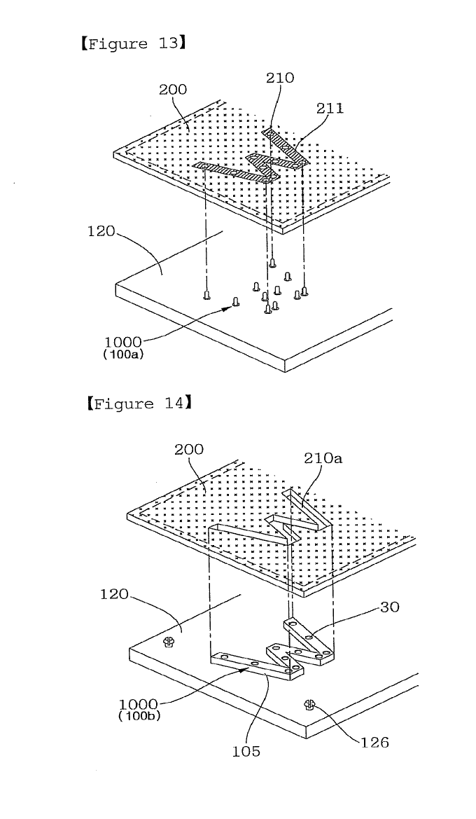

As shown in FIG. 13, the coupling holes 210 are spread over a graphics printing portion 211 of a letter or graphic shape.

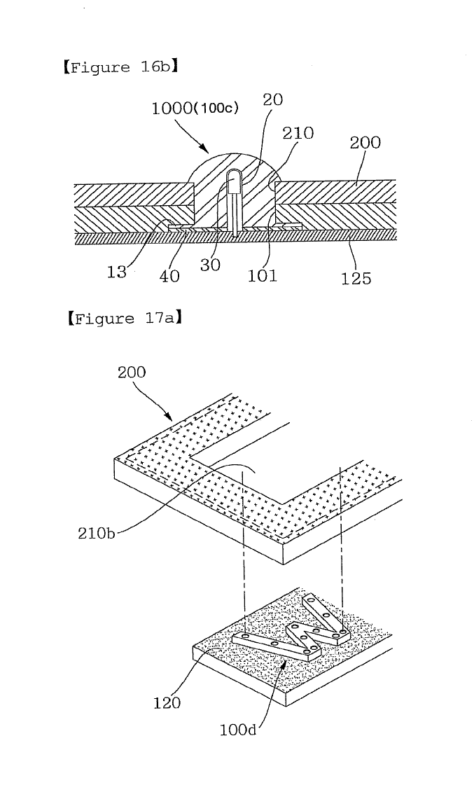

A fastener 126 as shown in FIG. 14 is added to the back surface of the footboard base 200 to hold and separate the luminous body support plate 120. As another example of the fastener, a pocket 125 as shown in FIG. 15b may be illustrated. In other words, one of a fastening hook, a fastening magnet, a magic tape, a binder, and a pocket 125 may be used as the fastener 126.

Based on the above basic construction, concretely in the fourth embodiment as shown in FIGS. 12, 13, 15a, and 15b, a tubular light emitting tube 102 is formed on the top surface of the luminous body support plate 120 supporting the luminous body 1000 (indicated as a luminous body 100a in the drawings in order to distinguish them from those in other examples), and a fastening hook 103 inserted and coupled to the upper end of the coupling hole 210 is formed at the upper edge of the light emitting tube 102, and the light emitting tube 102 has a diameter for holding the luminous lamp 30. Of course, it is preferable that the fastening hook 103 has a fastening coupling force of such an extent as to separate the light emitting tube 102 from the coupling hole 210 and couple it thereto. Such a construction for protrusion to strengthen the coupling force, obstructs separation, which is not preferable.

In FIG. 14 which illustrates the fifth embodiment of the present invention, a luminous body 1000 (indicated as a luminous body 100b in the drawings in order to distinguish them from those in other examples) is coupled to a light conductive resin 105 forming a letter using a synthetic resin polymer rod or synthetic resin plate for transmitting a transparent, semitransparent, or opaque light, and luminous lamps 30, such as a light emitting diode for emitting light, are coupled to the end or middle parts to transmit and emit light to the surface. The light conductive resin 105 forming a letter or graphic is inserted and coupled into coupling holes 210 having a letter or graphic shape, thereby making the assembling and dissembling of the footboard base 200 easier, and enabling the implementation of various colors due to the properties of resin.

The construction of FIGS. 16, 20, and 21 illustrating the sixth embodiment of the present invention includes a convex portion 10 forming luminous bodies 1000 (indicated as a luminous body 100c in the drawings in order to distinguish them from those in other examples) and having a larger diameter than coupling holes 210, a neck portion 101 having the same diameter as the coupling holes 210, an edge portion 13 having a larger diameter than the neck portion 101 and exerting a supporting force upon coupling, and a reflective layer 40 integrally or separately located below the edge portion 13. The neck portion 101 has the height for integrally coupling the footboard base 100 and the luminous body support plate 120. The luminous lamps 30 are inserted and coupled into insertion holes 20 penetrated upward on the bottom surface or lower side surface of the luminous body 100c. In this case, the reflective layer 40 may be integrally formed on the bottom surface of the neck portion 101 without the edge portion 13, or may be integrally formed on the edge portion 13, or may be configured to perform an indirect reflective function by using a plate (i.e., an upper surface plate of the pocket 125) integrally coupled to the bottom surface of the luminous body support plate 120. In this case, the fastener 126 as shown in FIG. 14 supporting the luminous body support plate 120 may fasten the support plate 120 by using the pocket 125 integrally formed on the footboard base 200 (in place of the fastener 126 or along with the fastener 126), and one of a fastening hook, a fastening magnet, a magic tape, and a binder may be used as the fastener 126.

In the seventh embodiment of the present invention, as shown in FIG. 17a, the letter-luminescent footboard comprises: a footboard base 200 having a large coupling hole 210b for displaying a letter, graphic, or number; a luminous body 1000 (indicated as a luminous body 100d in the drawings in order to distinguish them from those in other examples) coupled to the coupling hole 210b by insertion so as to be separated therefrom; and a luminous body support plate 120 which is exposed to the coupling hole 210b, supports the luminous body 100d, is integral with the luminous body 1000, and is separated therefrom and coupled thereto from below the footboard base 200. Thus, the footboard base 200 can be easily washed. In this case, the top surface of the coupling holes 210b may be illustrated with respect to a case in which a transparent plate 240 having a transparent cover function is installed as shown in FIG. 17b, and may be changed in design in various forms within the scope of performing the covering function.

The control configuration of the fourth to seventh embodiments of the present invention can be illustrated in the same manner as in FIG. 6, and thus a description thereof will be omitted.

FIG. 18 is a plane view showing an example of separating only the luminous bodies useable in FIG. 14 (fifth embodiment), FIG. 16 (sixth embodiment), and FIG. 17 (seventh embodiment). The luminous bodies 1000 are formed integral with each other at predetermined intervals on a base 110 made of a flexible polymer having a predetermined length.

FIG. 19 is a plane view showing another example of the luminous bodies 1000 used in FIG. 14, FIG. 16, and FIG. 17. An extension hole 13-1 for enabling sequential extension and connection through a connector 111 is formed on the edge portion 13 forming the edge of the convex portion 10 of each luminous body 1000.

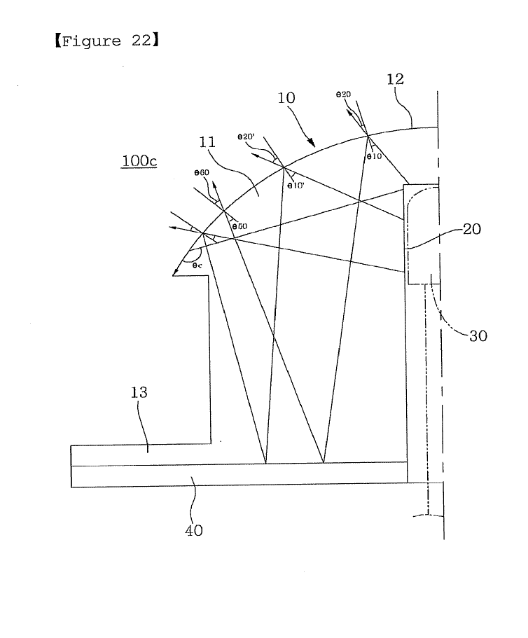

When the luminous lamps 30 serving as light sources generates light forward and laterally (side-lobe) on the clad layer 12 forming the surface of the core layer 11 as shown in FIGS. 21 and 22, the luminous body 1000 (indicated as a luminous body 100c in the drawings in order to distinguish them from those in other examples) according to the sixth embodiment used in the present invention functions such that the surface of the convex portion 10 has a uniform luminance because the light is transmitted at an incident angle (∂10) and at a refraction angle (am with respect to the normal line of each point of the convex surface forming the surface of the clad layer 12. Although the light of the luminous lamps 30 serving as light sources goes straight ahead on the core layer 11, the clad layer 12 forms a curved surface. Therefore, incident angles (∂10)(∂10′)(∂50) at most of the normal lines do not exceed a critical angle (∂c), to thus form refraction angles (∂20)(∂20′)(∂60) at each of the normal lines of the convex surface, so that the light is transmitted, thereby forming a uniform luminance on the surface of the convex portion (this luminous body 100 acts as a diffusive luminous body for uniformly lighting up the convex portion 10 having a larger diameter than the diameter of the luminous lamps 30, rather than in the concept of simple surface emission in which the light through the luminous lamps 30 merely goes straight ahead). It is apparent that each of the incident angles (∂10)(∂10′)(∂50) form refracting angles (∂30)(∂30′)(∂40) as indicated in FIG. 9 and refract light to the inner surface of the core layer 11 to thus transmit the light at a certain point, which may improve the luminance. In this case, the clad layer 12 is medium (i.e., air layer) which is provided with the direct advance of uniform light through a thermoplastic (thermosetting) synthetic resin polymer forming the core layer 11, thereby differentiating the refractivity.

Moreover, a semitransparent layer may be added to the surface of the clad layer 12 to provide a softened brightness, or fine mineral particles, such as TiO₂, may be added into the core layer 11 to transmit light in a semitransparent state.

By way of example as shown in FIG. 12 of the footboard base 200 forming a footboard using the luminous bodies 1000 having the function of diffusive light emission, the luminous bodies 1000 are arranged at predetermined intervals so as to form an array of letters (“WELCOME”) to a recognizable extent. As for the arrangement method, as in the fourth embodiment of FIGS. 13 and 15, a luminous body 100a is inserted and coupled into coupling hole 210 formed on the footboard base 200, and as shown in FIG. 14, the entire parts of EL lamps or light conductive resin 105 forming a letter may be coupled to the coupling hole 210a. Further, as shown in FIG. 15, a convex portion 10 is exposed on the coupling hole 210 formed on the footboard base 200, firstly coupled to a luminous body support plate 120 in such a way to support it through a neck portion 101, and then inserted and coupled to the coupling hole 210 of the footboard base 200, thereby coupling the luminous body support plate 120 and the footboard base 200.

Continuously, the control unit 130 as shown in FIG. 6 and a wire 133 for connecting the luminous lamps 30 are connected so that the luminous lamps 30 installed on each luminous body 100c emit light. As shown in FIG. 14 and/or FIG. 16b, the luminous body support plate 120 is coupled to the back surface of the footboard base 200 by a fastener 126 (i.e., a pocket 125 installed on the back surface of the footboard base 200 and/or a hook as shown in FIG. 14), so as to be separated therefrom and coupled thereto for washing. It is obvious that the luminous body 120 can be used even when it rains by configuring the supporting and control means of the luminous lamps 30 and the wire so as to be sealable. Such a sealing method may be implemented in various ways, and thus are minimally indicated in the drawings.

Accordingly, in any of the constructions of the fourth to seventh embodiments, when a switch 131 is turned on to supply power of a battery 132 to the control unit 130, the luminous lamps 30 or EL lamps disposed to display letters are switched on, and thus function as a letter-luminescent footboard which display letters.

In particular, the luminous bodies 1000 emitting light to display letters, especially, luminous bodies 100b, 100c, and 100d, act to diffuse the light emission area of the light. Thus, the present invention can display a letter brightly even if a small number of luminous lamps 30 is used, can cut down costs unlike the letter luminescent method using many lamps even if the number of use of the luminous lamps 30 is decreased, can provide the effect of softened light emission because the convex portion 10 forms a uniform luminance as the light is diffused, thereby offering the effect of a softened light emission, and can provide a placard which non-glaring and appearing.

Further, with respect to the normal line of each point of the convex surface forming the surface of the clad layer 12, as illustrated in FIG. 22, light is transmitted at an incident angle (∂10) and at a refracting angle (∂20), and accordingly the surface of the convex portion 10 forms a uniform luminance. Although the light of the luminous lamps 30 serving as light sources goes straight ahead on the core layer 11, the clad layer forms a curved surface. Therefore, incident angles (∂10)(∂10′)(∂50) at most of the normal lines do not exceed a critical angle (ac), to thus form refraction angles (∂20)(∂20′)(∂60) at each of the normal lines of the convex surface, so that the light is transmitted, thereby forming a uniform luminance on the surface of the convex portion (this luminous body 100 acts as a diffusive luminous body for uniformly lighting up the convex portion 10 having a larger diameter than the diameter of the luminous lamps 30, rather than with a simple surface emission in which the light through the luminous lamps 30 merely goes straight ahead). It is apparent that each of the incident angles (∂10)(∂10′)(∂50) form refracting angles (∂30)(∂30′)(∂40) and refract light to the inner surface of the core layer 11 to thus transmit the light at a certain point, which may improve the luminance. In this case, the clad layer 12 is medium (i.e., air layer) which is provided with the direct advance of uniform light through a thermoplastic (thermosetting) synthetic resin polymer forming the core layer 11, thereby differentiating the refractivity.

By way of example as shown in FIG. 12 of the footboard base 200 forming a footboard using the luminous bodies 1000 having the function of diffusive light emission, the luminous bodies 1000 are arranged at predetermined intervals so as to form an array of letters (“WELCOME”) to a recognizable extent. As for the arrangement method, as in the fourth embodiment of FIGS. 13 and 15, a luminous body 100a is inserted and coupled into coupling hole 210, and as shown in FIG. 14 illustrating the fifth embodiment, the luminous body 100b made of light conductive resin forming a letter or graphic is exposed on the coupling hole 210a.

Further, as shown in FIG. 16 of the sixth embodiment, the luminous body 100c is inserted and coupled into the coupling hole 210 and the edge portion 13 is overlapped with and supported on the edge of the coupling hole 210. Accordingly, the luminous body 100c integral with the luminous body support plate 120 is coupled to and separated from the footboard base 200 along with the support plate 120.

Further, as shown in FIG. 17 of the seventh embodiment, the luminous body 100d and the luminous body support plate 120 are integrally coupled to and separated from the coupling hole 210b.

Of course, in order to separate it, it should be removed from the pocket 125 as shown in FIG. 16b, or separated through the fastener 126 as shown in FIG. 14, so that it is coupled in use and only the footboard base 200 is separated when washing.

It is apparent that the present invention has a construction in which the footboard base 20 and the luminous body 1000 may be separated or coupled, and the entire section forming a letter may be separated or only one part of many forming a letter may be separated. Moreover, the luminous body 1000 of the present invention can be implemented in other means capable of light emission, such as a diffusive luminous body, a waveguide, a conductive polymer, a light emission tape, an EL lamp, etc.

As apparent from the above description, the present invention has the following advantages:

First to third embodiments of the present invention provide a letter-luminescent footboard, which can display a letter by lamps. Accordingly, it can be folded for portability and easy storage, can be used anywhere as there is no need to supply an external power source since it uses a battery, can be used for a long time because power consumption is low due to using luminous lamps as LED's, and can be used in all weather both indoors and outdoors because the back plate of the footboard base is coupled to be sealable.

The footboard utilizes the diffusive luminous bodies that are aligned to form letters and diffuse lights. Therefore, it can display the letters using a relatively small number of luminous lamps and cut down costs.

The diffusive luminous bodies emit light through their convex surface with uniform luminance as the light is diffused. Therefore, it can protect the user's eyes and offer the effect of softened light emission to maximize the advertisement effect.

The diffusive luminous bodies are driven by a battery. Therefore, the footboard can be freely moved and used at any place, and, in particular, can be used in the night for advertisement effect without any additional external lamp, which makes it cost-effective and maximizes the advertisement effect.

The footboard can display letters by emitting light at night. Therefore, it can serve as an advertisement.

The footboard base of the footboard is manufactured to use a small number of diffusive luminous bodies. Therefore, the weight of the footboard is light so that a user can bring it conveniently, and can be installed in the building entrance.

When the footboard is configured to include solar cell that supplies power to the luminous lamps coupled to the footboard, it can be used semi-permanently. This footboard can be easily installed at any place and conveniently replaced from the place. Also, this footboard can serve to its inherent function in the day time and to the signboard for guidance at night.

When the footboard base and the back plate are made of waterproofing cloth or carpet, and synthesis resin sheet, etc., the footboard becomes attractive and does not cause a leak of electricity in the bottom. Therefore, the footboard can be used as a variety of use, such as footboards at any entrance, floor, restaurant entrance, and even such as a wall ornament. The footboard can be implemented in various forms including numbers, symbols, pictures, characters, etc. Therefore, it can be variously used.

Furthermore, fourth to seventh embodiments of the present invention enable washing of the footboard as the footboard base and a footboard support plate forming a letter or graphic can be separated from each other to allow for easier washing.

The present invention forms letters or a graphic in such a way that the luminous bodies are installed to an additional luminous body support plate. Instead of the luminous bodies, a variety of light emitting means can be selected and installed to the luminous body support plate.

The present invention can offer various guidance and advertisement effects by a combination of lighting and printing by spreading the same over a graphics printing portion that has letters or graphics printed on the regions forming coupling holes.

The present invention allows luminous holes to form a large space of a predetermined dimension, and allows luminous bodies for displaying letters or graphics on this space and a support plate for supporting the luminous body to be integrally placed at the region corresponding to the luminous holes, thereby making the footboard stereoscopic.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1.-14. (canceled)

15. A letter-luminescent footboard comprising:
a footboard base having a large coupling hole for displaying a letter, graphic, or number all together;
a luminous body coupled to the coupling hole by insertion so as to be separated therefrom; and
a luminous body support plate which is exposed to the coupling hole, supports the luminous body, is integral with the luminous body, and separates a fastener from the luminous body.

16. The footboard according to claim 15, wherein the top surface of the coupling holes is installed by a transparent plate having a transparent cover.

17. The footboard according to claim 15, wherein the fastener includes a pocket.

18. The footboard according to claim 15, wherein the fastener is one of a fastening hook, a fastening magnet, a magic tape, and a binder.
